(19) United States
(12) Patent Application Publication
(10) Pub. No.: US 2020/0051110 A1
(43) Pub. Date: Feb. 13, 2020

(54) METHOD AND SYSTEM FOR FACILITATING INSTALLMENT PAYMENT WITH REWARD POINTS

(71) Applicant: MASTERCARD INTERNATIONAL INCORPORATED, Purchase, NY (US)

(72) Inventor: Vidit BHARGAVA, Pune (IN)

(21) Appl. No.: 16/537,829

(22) Filed: Aug. 12, 2019

(30) Foreign Application Priority Data
Aug. 13, 2018 (SG) 10201806840X

(51) Int. Cl. G06Q 30/02; G06Q 20/14

(52) U.S. Cl. CPC G06Q 30/0215; G06Q 20/14

(57) ABSTRACT

Embodiments provide a computer-implemented method including receiving, by a server system associated with a payment network, a request for an installment payment for a purchase amount. The installment payment is to be paid at least partially from reward points available with a payment card of a cardholder. The method includes determining, by the server system, a required number of reward points for a payment of the purchase amount in response to the request for the installment payment. The method further includes, accessing, by the server system, one or more payment term plans for the installment payment, wherein each of the one or more payment term plans is determined based at least on the required number of reward points. Each payment term plan includes a set of reward points needed to be used for payment corresponding to each installment of the installment payment.

### TECHNICAL FIELD

The present disclosure relates to payment card related payment transactions and, more particularly to, a method and system for facilitating payments with rewards points.

### BACKGROUND

Nowadays, in purchase transactions users are provided various options on how the users wish to pay for their purchase. This applies to financial transactions made at point-of-sale (POS) terminals as well as online purchase transactions using several banking cards, such as credit cards, debit cards, prepaid cards, etc. The options may include, but are not limited to, payment by cash, payment using cards, payment by internet banking, payment with rewards/loyalty points and payment in parts (i.e. installments).

For very huge purchase amounts, many users often opt to settle the purchase amount by paying in installments as the users may not have with them the required purchase amount during the purchase. Moreover, many users may not be willing to release such a huge sum of money at once and instead choose to avail the luxury of paying in installments. In case of a payment made in installments, a series of payments are made instead of a lump sum amount to compensate the seller. In current scenarios, for payments done in installments, the user is required to pay the purchase amount in parts every month. In a convention scenario, the installment amount to be released to the seller is paid in terms of currency. The installment amount may include a part of the principal purchase amount and a part of interest levied on the purchase amount. On a due date of the installment payment, the user's card may not able to release the required installment amount for various reasons, such as insufficient funds. Further, if the installment amount is not paid by due date, the user may have to face consequences, in form of fines. Currently, there are no alternative means of paying the installment amount every month other than with currency.

### SUMMARY

Various embodiments of the present disclosure provide systems, methods, electronic devices and computer program products to facilitate installment payment with reward points. Various embodiments of the present disclosure provide systems and methods for presenting/suggesting optimum payment term plan to a cardholder.

An embodiment provides a computer-implemented method. The method includes receiving, by a server system associated with a payment network, a request for an installment payment for a purchase amount, the installment payment to be paid at least partially from reward points available with a payment card of a cardholder. The method includes determining, by the server system, a required number of reward points for a payment of the purchase amount in response to the request for the installment payment. The method further includes, accessing, by the server system, a payment term plan for the installment payment, wherein the payment term plan is determined based at least on the required number of reward points. The payment term plan comprises a set of reward points needed to be used for payment corresponding to each installment of the installment payment.

Another embodiment provides a payment server in a payment network. The payment server includes a memory comprising stored instructions and a processor configured to execute the stored instructions to perform receiving a request for an installment payment for a purchase amount, the installment payment to be paid at least partially from reward points available with a payment card of a cardholder. The processor is configured to perform determining a required number of reward points for a payment of the purchase amount in response to the request for the installment payment. The processor is configured to perform accessing a payment term plan for the installment payment, wherein the payment term plan determined based at least on the required number of reward points and the payment term plan comprises a set of reward points needed to be used for payment corresponding to each installment of the installment payment. The processor is further configured to perform facilitating sending a notification for an approval of the payment term plan for the installment payment to the cardholder. Upon receiving the approval of the cardholder, the processor is further configured to perform setting the installment payment as per the payment term plan.

Another embodiment provides a payment server in a payment network. The payment server includes an installment payment module, pay by reward (PBR) module and a communication interface. The installment payment module is configured to receive a request for an installment payment for a purchase amount, the installment payment to be paid at least partially from reward points available with a payment card of a cardholder. The PBR module is configured to determine a required number of reward points for a payment of the purchase amount in response to the request for the installment payment. The communication interface, upon receiving instructions from the PBR module, is configured to send the required number of reward points and the request for the installment payment to an issuer server associated with the cardholder. The communication interface is further configured to receive a payment term plan for the installment payment from the issuer server, the payment term plan determined based at least on the required number of reward points by the issuer server, the payment term plan comprising a set of reward points needed to be used for payment corresponding to each installment of the installment payment. The communication interface is further configured to send a request to the issuer server to for an approval of the payment term plan for the installment payment from the cardholder. The communication interface is further configured to receive the approval of the cardholder via the issuer server wherein the pay by reward module is further configured to set the installment payment as per the payment term plan.

Another embodiment provides an issuer server in a payment network. The issuer server includes a memory comprising stored instructions and a processor. The processor is configured to execute the stored instructions to perform a method comprising receiving a request for an installment payment for a purchase amount from a payment server in the payment network, wherein the installment payment is to be paid at least partially from reward points available with a payment card of a cardholder. The processor is further configured to perform a method comprising receiving a required number of reward points for a payment of the purchase amount. The processor is further configured to perform a method comprising determining a payment term plan for the installment payment, the payment term plan comprising a set of reward points needed to be used for payment corresponding to each installment of the installment payment, wherein the payment term plan is determined based at least on the required number of reward points, one or more card usage criteria of the payment card and a total of the reward points available with the payment card. The processor is further configured to perform a method comprising sending a notification for an approval of the payment term plan for the installment payment to the cardholder and upon receiving the approval of the cardholder, facilitating setting the installment payment as per the payment term plan.

### BRIEF DESCRIPTION OF THE DRAWINGS

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 represents a schematic representation of an issuer server registering/enrolling for the integrating installment payments with the pay by rewards (PBR) feature facilitated by a PBR module, in accordance with an embodiment of the present disclosure;

FIG. 3 represents a sequence flow diagram representing a method of presenting/suggesting a payment term plan for a payment card of a cardholder, in accordance with an example embodiment of the present disclosure;

FIG. 4 represents a sequence flow diagram illustrating a method of facilitating installment payment with reward points for a payment card of a cardholder during a purchase, in accordance with an example embodiment of the present disclosure;

FIG. 5 represents a sequence flow diagram representing a method of presenting payment term plans for the plurality of payment cards of a cardholder added in a wallet application, in accordance with an example embodiment of the present disclosure;

FIGS. 6A and 6B are example representations of two tables, displaying payment schedules of installment payment with reward points, maintained at an issuer database, in accordance with an example embodiment of the present disclosure;

FIGS. 7A and 7C are example representations of two tables illustrating retrieval of the reward points usage history associated with two distinct payment cards of the cardholder issued by two distinct issuers, in accordance with an example embodiment of the present disclosure;

FIGS. 7B and 7D are example representations of two tables, displaying two distinct payment term plans for a purchase amount displayed in FIG. 6A based on the reward points usage history determined in FIGS. 7A and 7C, in accordance with an example embodiment of the present disclosure;

FIG. 8 illustrates a flow diagram of a method for facilitating access to a payment term plan suggested to a cardholder by an issuer server, in accordance with one embodiment of the present disclosure;

FIG. 9 is a simplified block diagram of a server system used for presenting/suggesting a payment term plan to the cardholder, in accordance with one embodiment of the present disclosure;

FIG. 10 is a simplified block diagram of an issuer server used for presenting/suggesting a payment term plan to the cardholder, in accordance with one embodiment of the present disclosure;

FIG. 11 is a simplified block diagram of an acquirer server used for presenting/suggesting a payment term plan to the cardholder, in accordance with one embodiment of the present disclosure;

FIG. 12 is a simplified block diagram of a payment server used for presenting/suggesting a payment term plan to the cardholder, in accordance with one embodiment of the present disclosure; and

FIG. 13 shows simplified block diagram of a user device for example a mobile phone or a desktop computer capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer account” used throughout the description refers to a financial account that is used to fund the financial transaction (interchangeably referred to as “payment transaction”). The “acquirer account” used throughout the description refers to a financial account of a merchant or any entity which receives the fund from the issuer account. Further, the “acquirer account” used throughout the description refers to a financial account of a beneficiary. Herein, beneficiary refers to an individual or an entity who receives money from someone. Examples of the issuer account and the acquirer account include, but are not limited to a savings account, a credit account, a checking account and a virtual payment account. Each of the issuer account and the acquirer account may be associated with an entity such as an individual person, a family, a commercial entity, a company, a corporation, a governmental entity, a non-profit organization and the like. In some scenarios, an issuer or acquirer account may be a virtual or temporary payment account that can be mapped or linked to a primary payment account, such as those accounts managed by PayPal®, and the like.

The term “payment card”, used throughout the description, refer to a physical or virtual card linked with a financial or payment account that may be presented to a merchant or any such facility in order to fund a financial transaction via the associated payment account. Examples of the payment card include, but are not limited to, debit cards, credit cards, prepaid cards, virtual payment numbers, virtual card numbers, forex card, charge cards and stored-value cards, digital wallets, etc. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Overview

Various embodiments of the present disclosure provide systems, methods, electronic devices and computer program products to facilitate installment payment for a purchase with reward points. Various embodiments of the present disclosure further provide systems and methods for determining payment term plan based on one or more criteria, such as availability of reward points and payment history associated with a payment card of a user and presenting the payment term plan to the user.

A server system such as a payment server and/or an issuer server, is provided. The payment server includes an installment payment module and a pay by rewards (PBR) module. Issuers may have to enroll for integrating installment payment with rewards feature facilitated by the PBR module such that all cardholders holding payment cards issued by the issuer can avail the benefit of installment payment with reward points.

A user (e.g., a cardholder), at any instant during or before a purchase, may check if a payment card of the user is eligible for installment payment with reward points. If the payment card is eligible for the installment payment, the user may request for a payment term plan for making installment payment at least partially using reward points. A user device associated with the user may have an issuer application facilitated by an issuer server installed therein. A request for a payment term plan is received at the installment payment module of the payment server via the issuer server. The installment payment module sends a request to the PBR module to convert a purchase amount into reward points based on a conversion formula defined by the issuer server and/or the payment server. The conversion formula may be retrieved by accessing an issuer database. As an example, the conversion formula may be such as 10 reward points=$1. Hence, if a purchase amount is $100, as many as 1000 reward points may be required for the purchase. The installment payment module further notifies the issuer server on the overall required reward points and reward point to be maintained in the payment card every month. The PBR module responds to the installment payment module with the conversion result. The installment payment module also checks whether the issuer server/issuer has enrolled for the pay by rewards feature.

Upon receiving the conversion result, the installment payment module sends a request to the issuer server to present a payment term plan for the payment card. The issuer server checks one or more criteria such as availability of required reward points, payment history, etc., associated with the payment card and/or the issuer account linked to the payment card and determines an optimum payment term plan for the user which is displayed at the user device. It shall be noted that the reward points can be made use of in an installment payment each month. The payment term plan is an example payment schedule which includes a payment term including the number of months for which the installment payment is to be made, an installment amount for each month and the number of reward points equivalent to the installment amount for each month. The payment term plan further includes a purchase amount and other charges (such as rate of interest) that is levied on the purchase amount in case of installment payment. The user further provides approval on the payment term plan, and based on the approval, the payment term plan is set for the purchase made by the user. The installment payment is settled based on the approved payment term.

In some embodiments, customization options may be provided to the users. For instance, instead of presenting one optimum payment term plan, 3-4 payment term plans can be shown to a user. For instance, in one suggested plan, the user can be offered to pay installment amount using 100 reward points every month and remaining amount of monthly installment from his bank account (e.g., payment card account). In another suggested plan, the user may be offered to pay 50$ from his bank account and remaining monthly installment amount by way of reward points, for the purchases made by the user. The user may select one payment term plan from the displayed payment term plans, and the selected payment term plan can be set for the installment payment for the user. It should also be noted that the payment term plans presented to two different users, for example, user A and user B may be different based on the spend history (e.g., payment card usage history) and repayment history of the users A and B. For instance, if a historical spend and repayment pattern of the user A suggests that the user A prefers utilizing 100 reward points every month, the user A can be presented with at least one payment term plan that includes a monthly utilization of 100 reward points for the installment payment. Similarly, if a historical pattern of the user B suggests that the user B prefers paying 50 $ from his bank account and remaining balance of monthly installment by way of reward points, the user B can be presented with at least one payment term plan that covers similar payment terms.

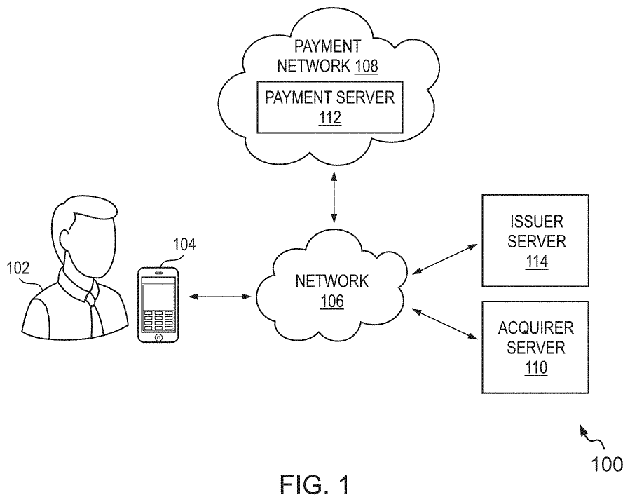

FIG. 1 illustrates an example representation of an environment 100, in which at least some example embodiments of the present disclosure can be implemented. In the illustrated embodiment, a user/cardholder 102 of a payment card (not shown) is seen operating a user device 104. The user 102 can be present at a merchant facility (not shown) for performing POS transaction with a payment card (not shown) for a purchase. Alternatively, the user 102 can be operating the user device 104 at a location such as the user's home for performing online transactions without visiting the merchant facility.

The user device 104 may include applications such as ecommerce applications associated with merchants or third-party service providers that aggregate services and products from a plurality of merchants and make them available on a single platform, such as the application. Alternatively, in case of a POS transaction, the user 102 may walk into the merchant facility and perform usual POS transactions by swiping or inserting payment cards at a POS card reader device.

Examples of the user device 104 include, but are not limited to, a smartphone, a tablet, a personal digital assistant (PDA), a notebook, a laptop, a desktop, etc. As an example, the user device 104 of FIG. 1 is depicted as a smartphone. However, it shall be understood that, the user device 104 is not limited to a smartphone and can include any electronic devices of the likes of a smartphone and having the capability to allow installation of third-party applications and communicate with other devices via a network 106. In the present disclosure, the user device 104 may preferably be a mobile electronic device (such as a smartphone or a tablet).

The user device 104 may be equipped with an instance of an issuer application installed therein. The application and its components may rest in an issuer server 114. The application is a set of computer executable codes configured to perform the method disclosed herein. The set of computer executable codes may be stored in a non-transitory computer-readable medium of the user device 104. The user device 104 can communicate with the issuer server 114 through the application. Alternatively, the user device 104 may be equipped with an instance of a payment server application installed therein.

The user 102 may be operating the user device 104 for purchase of goods and services offered by a merchant. The user device 104 may be used for various purposes such as for checking whether an installment payment for the purchase is available and whether an installment payment with reward points is available for the purchase. The user device 104 may be used to check whether a payment card of the user 102 and/or an issuer bank issuing the payment card is provides the facility for installment payment with reward points. The user 102 can access the issuer application to check whether the payment card is eligible for installment payment with reward points or whether an installment payment can be paid at least partially with reward points. The user 102 can request for a payment term plan against a purchase and provide approval for a payment term plan determined specifically for the user 102 (i.e. the payment card of the user 102).

A payment transaction for a purchase between the user 102 (issuer account) and a merchant (acquirer account) may be facilitated by the server system and a payment network 108. Examples of the server system include the issuer server 114, an acquirer server 110 and a payment server 112. In some cases, the issuer server 114, the acquirer server 110 and the payment server 112 can be a single entity, or any two of these servers may be a single entity.

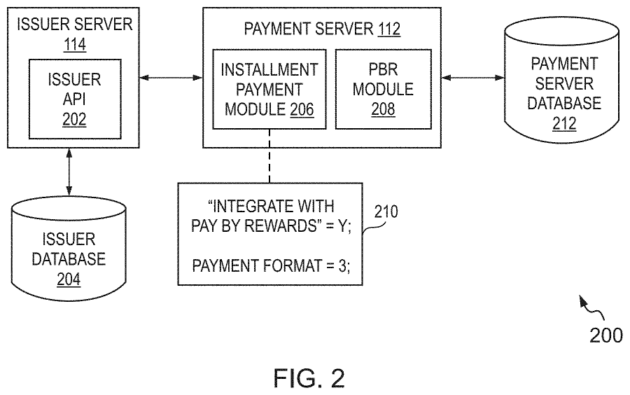

The issuer server 114 is associated with a financial institution normally called as an “issuer bank” or “issuing bank” or simply “issuer” or simply “bank”, in which the user 102 may have an issuer account. The issuer server 114 includes Application Programming Interface (API) configured to build and manage a desktop application or a mobile application. The user 102 has an issuer account in the issuer. The issuer server 114 is responsible for managing user information of the user 102. The issuer server 114 includes an issuer database (shown in FIG. 2) for maintaining information such as one or more issuer accounts of the user 102, transaction/payment history related information, payment cards, permanent account number (PAN) with which the one or more issuer accounts are linked, etc.

The acquirer server 110 is associated with a financial institution normally called as an “merchant bank” or the “acquiring bank” or “acquirer bank” or simply “acquirer”, in which the merchant may have account. The acquirer server 110 is responsible for managing merchant account details and processing settlement of funds received from an issuer account of the user 102. In an embodiment, the environment 100 may include a plurality of acquirers associated with the one or more merchants. Similarly, the environment 100 may include a plurality of issuers.

In one embodiment, the payment server 112 is associated with the payment network 108. The payment network 108 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard® International Incorporated for the exchange of financial transaction data between financial institutions that are members of Mastercard International Incorporated®. (Mastercard is a registered trademark of Mastercard International Incorporated located in Purchase, N.Y.). The payment server 112 includes an installment payment module and a PBR module (both shown in FIG. 2) associated with the payment network 108.

Using the payment network 108 the computers of the acquirer server 110 or a merchant device will communicate with the computers of the issuer server 114 to determine whether the user's issuer account is in good standing and whether a purchase is covered by the user's available credit line or account balance or available reward points. Based on these determinations, the payment transaction is generally performed.

The user device 104, the issuer server 114, the acquirer server 110 and the payment server 112 communicate with one another using the network 106. Examples of the network 106 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 106 may be or include the Internet, intranets, extranets, microwave networks, satellite communications, cellular systems, personal communication services (“PCS”), infrared communications, global area networks, or other suitable networks, etc., or any combination of two or more such networks.

Reward points as described herein can be equivalent to an amount expressed in a currency and can be used during payment transactions. For example, 100 reward point may be equivalent to $10. Reward points are awarded to users of payment cards issued by issuers while using the payment cards in financial transactions. Each payment card transaction may earn the users a certain number of reward points depending upon the type of payment card, an amount of the transaction, and in some cases, on the category of goods or services purchased. Generally, an issuer of a payment card may set milestones on accrual of reward points and a user after reaching a milestone may redeem the reward points towards purchase of certain goods or services.

It shall be noted that issuers may have to enroll for integration of installment payments with a pay by rewards feature facilitated by the PBR module such that all customers (such as the cardholder 102) of the issuer can avail the benefit of installment payment at least partially with reward points. Additionally, upon enrollment of the issuer for the pay by rewards feature, the facility of installment payment with reward points is extended to the payment cards issued to its customers by the issuer. Once the issuer has enrolled or registered for this feature, the payment cards issued by the issuer are enabled with the facility of installment payment with reward points. FIG. 2 represents a schematic representation 200 of an issuer server (such as the issuer server 114) registering/enrolling for the integrating installment payments with the pay by rewards feature facilitated by the PBR module, in accordance with an embodiment of the present disclosure.

As seen in FIG. 2, the issuer server 114 includes an issuer API 202. The issuer API 202 includes a set of functions and procedures configured to build and manage an issuer application that can be made available at user devices, such as the user device 104. The issuer application is downloadable from application stores managed by Google® (Android), Apple®, Microsoft®, etc. Further, the issuer API 202 manages API calls between the issuer application installed at the user device 104 and the issuer server 114. The representation 200 further displays an issuer database 204 associated with the issuer server 114. The issuer database 204 stores information such as one or more issuer accounts of the user 102, transaction/payment history related information, payment cards, installment payment terms, reward points, permanent account number (PAN) with which the one or more issuer accounts are linked, etc.

The payment server 112 as seen in FIG. 2 includes an installment payment module 206 and a PBR module 208. The installment payment module 206 is configured to facilitate a digital platform/interface 210 of the payment server 112 allowing issuer servers such as the issuer server 114 to enroll for integration of installment payments with the pay by rewards facility. In an example embodiment, the issuer server 114 logs in to the digital platform 210 facilitated by the installment payment module 206. In a non-limiting implementation, the issuer server 114 is allowed to define a field with an example instruction such as “Integrate with Pay by Rewards”=Y; Payment Format=3. As an example, the payment format field may define the criteria for suggesting a payment term plan to the cardholder 102. Upon defining the fields in the digital platform 210, the issuer server 114, the cardholders and the payment cards associated with the issuer server 114 are now eligible for installment payments with the pay by rewards facility.

The installment payment module 206 is further configured to notify the issuer server 114 on how much installment amount is to be collected from cardholders on a monthly basis. The issuer server 114, the installment payment module 206 and the PBR module 208 are in operative communication through the network 106 as and when the cardholder 102 requests for payment term plans and/or when the cardholder 102 makes a purchase with installment payment with reward points. The PBR module 208 is configured to convert a purchase amount into reward points and the payment server 112 sends the reward point calculation to the issuer server 114 which uses the calculation to determine optimum payment term plans based on one or more criteria and present/suggest the payment term plans, thus determined, to cardholders.

The payment server 112 also accesses a payment server database 212. The payment server database 212, among other information corresponding to the payment server 112, stores one or more conversion formula(e) for conversion of purchase amount to reward points. The payment server database 212 further includes information on enrollment of issuer servers. The payment server database 212 further includes information associated with the merchant, the acquirer server 110 and the issuer server 114.

A user such as the user/cardholder 102 may have made a purchase worth a sum of money in an online purchase transaction. The online purchase transaction is initiated in an application such as an ecommerce application associated with a merchant or a third party service provider. The user may be willing to opt for installment payment with reward points for the purchase amount, which would ensure that the purchase is almost free of cost. The user 102 may check the eligibility of a payment card he/she is willing to make payment with and request for available payment terms plans.

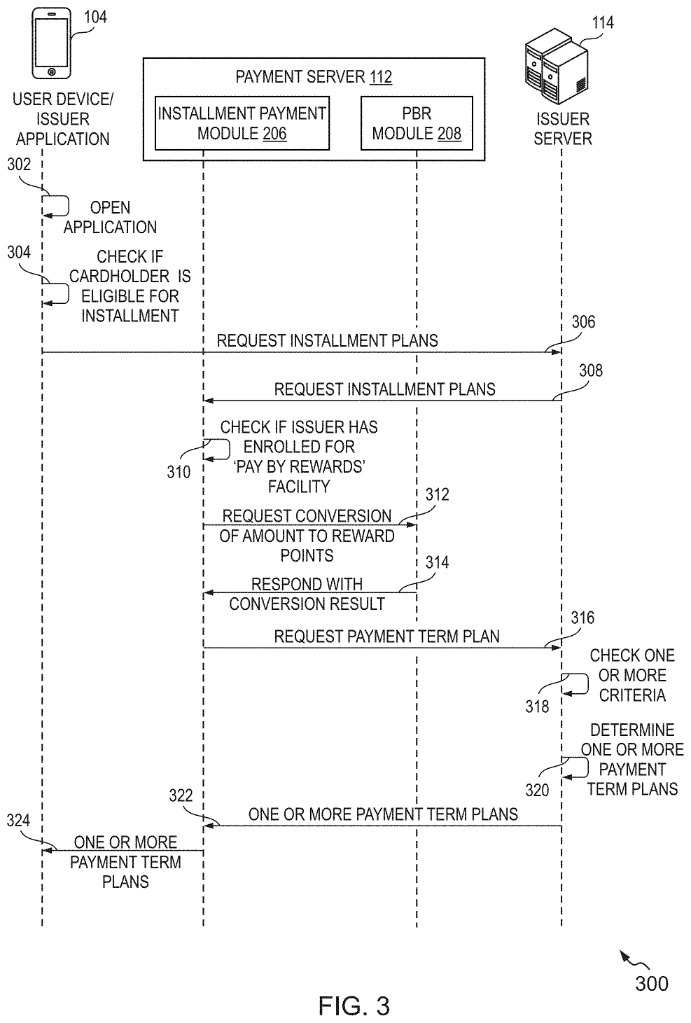

FIG. 3 represents a sequence flow diagram 300 representing a method of presenting/suggesting a payment term plan for a payment card of a cardholder, in accordance with an example embodiment of the present disclosure. The user 102 may log in to an application on the user device 104.

At 302, the user 102 opens an application on the user device 104. The application can be an issuer application or a payment server application or even a third party application. The application is available at and downloadable from application stores such as Google® Play Store, Apple® app store, Windows® store, etc. The application may be a mobile application or a desktop application.

At 304, the user 102 checks if the user 102 or the payment card is eligible for installment payment with reward points. If the issuer server 114 is enrolled for the feature of integrating installment payment with reward points, the cardholder 102 or the cardholder's payment card issued by the issuer is eligible for at least installment payment to be paid partially with reward points. It shall be noted that, an interface of the issuer application may present actionable icons (not shown) to allow checking of eligibility. Eligibility information can be notified in the interface of the issuer application. Alternatively, eligibility information can be notified as text message or email. It shall be noted that if the issuer server 114 is not enrolled for the installment payment with reward points feature, then the cardholder 102 can request the issuer server 114 for such enrollment.

At 306, the user device 104 sends a request to the issuer server 114 for receiving payment term plans in the issuer application. The request may include the purchase amount for which installment payment is sought. The request is received by the issuer server 114. It shall be noted that if the application is a payment server application, the request would be directly received by the payment server 112.

At 308, the issuer server 114 sends the request to the payment server 112. It shall be noted that the request is processed at the installment payment module 206 of the payment server 112.

At 310, the installment payment module 206 checks if the issuer server 114 from which the request is received has enrolled for integrating installment payment with reward points feature. The installment payment module 206 queries the payment server database 212 to access information corresponding to enrollment of the issuer server 114 for the installment payment with reward points feature. It shall be noted that if the issuer server 114 is not enrolled for the installment payment with reward points feature, then the payment server 112 may notify the cardholder 102 of the same and the cardholder 102 can request the issuer server 114 for such enrollment.

At 312, the installment payment module 206 sends a request to the PBR module 208 for conversion of the purchase amount to reward points. At 314, the PBR module 208 sends the conversion result to the installment payment module 206. The conversion result includes the total reward points worth the purchase amount. The conversion may be performed based on a conversion formula. It shall be noted that the conversion formula may be defined by the issuer. In such instances, the conversion formula may be retrieved from the issuer database 204. Alternatively or additionally, the conversion formula may be defined by the payment server 112 and can be retrieved from the payment server database 212.

Upon receiving the conversion result, at 316, the installment payment module 206 or the payment server 112 requests for a payment term plan to the issuer server 114. At 318, the issuer server 114 checks for one or more criteria based on which the payment term plan may be calculated. The one or more criteria include, but are not limited to, payment history associated with the payment card, available reward point in the card, other existing payment term plans associated with the payment card, etc. It shall be noted that the issuer database 204 may store one or more generic installment plans for all cardholders.

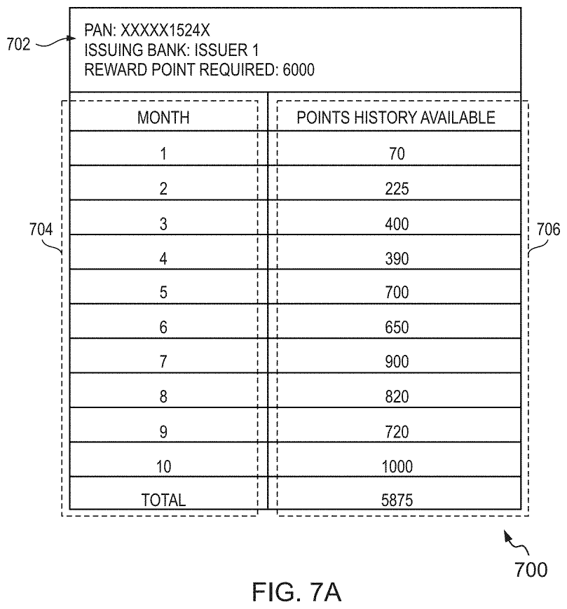

At 320, the issuer server 114 determines one or more payment term plans based on the one or more criteria as described earlier. For instance, if payment history of a first user (user A) suggests that the user A prefers utilizing 50 reward points every month, at least one payment term plan is determined for the user A that includes a monthly utilization of 50 reward points for the installment payment. In another example, payment history of a second user (user B) suggests that the user B prefers paying 50 $ from his bank account and remaining balance of monthly installment by way of reward points. In this example, considering there are 5000 reward points available with the user B, at least one payment term plan is determined for the user B that suggests an installment payment of 50$ from bank account and utilization of 100 reward points (1 reward point=1$) for 24 months for a total purchase of 3500 $ (including interest, processing fee, etc.). It shall be noted that an optimum payment term plan is determined by the issuer server 114. At 322, the issuer server 114 makes the payment term plan accessible to the payment server 112. In an example, the issuer server 114 directly presents the payment term plan (see 720 in FIG. 7B and 770 in FIG. 7B) to the cardholder 102 on the user device 104 in the issuer application.

At 324, the payment server 112 presents the one or more payment term plans to the cardholder 102 on the user device 104. The payment term plans can be presented in a text message or an email or as a notification in the issuer application installed in the user device 104.

It is to be noted that the payment term plan is an example payment schedule displaying the number of installments. The schedule includes the number of months for which the installment payment is to be made, an installment amount for each installment of the installment payment and the number of reward points equivalent to the installment amount for each installment of the installment payment. The payment term plan further includes a purchase amount and other charges (such as rate of interest) that is levied on the purchase amount in case of installment payment. The user further provides approval on the payment term plan. The approved payment term plan is then set for the payment card of the cardholder. The installment payment is settled based on the approved payment term plan. The payment term plan may further include a due date for each installment.

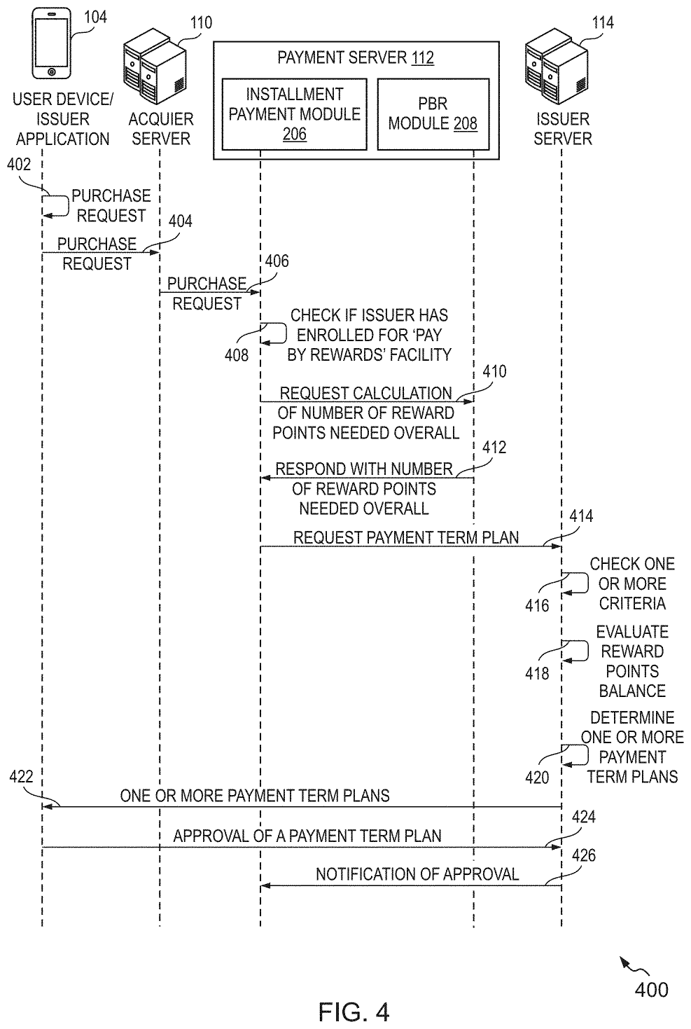

FIG. 4 represents a sequence flow diagram 400 illustrating a method of facilitating installment payment with reward points for a payment card of a cardholder during a purchase, in accordance with an example embodiment of the present disclosure. It is assumed that the cardholder 102 may have made a purchase worth a sum of money in an online purchase transaction and that the cardholder 102 is aware that his/her payment card is eligible for installment payment with reward points. The online purchase transaction is initiated in an application such as an e-commerce application associated with a merchant or a third party service provider.

At 402, a purchase request is initiated at the user device 104 in the ecommerce application. At 404, the purchase request is sent to the acquirer server 110. The purchase request may include a purchase amount and payment card information.

At 406, the purchase request is received at the payment server 112 and more specifically, at the installment payment module 206. It shall be noted that the purchase request is processed at the installment payment module 206 of the payment server 112.

At 408, the installment payment module 206 checks if the issuer server 114 from which the request is received has enrolled for integrating installment payment with reward points feature. The installment payment module 206 queries the payment server database 212 to access information corresponding to enrollment of the issuer server 114 for the installment payment with reward points feature. It shall be noted that if the issuer server 114 is not enrolled for the installment payment with reward points feature, then the payment server 112 may notify the cardholder 102 of the same and the cardholder 102 can request the issuer server 114 for such enrollment.

At 410, the installment payment module 206 sends a request to the PBR module 208 for calculation of number of reward points needed overall for settling the purchase amount with reward points or at least settling the purchase amount partially with reward points. At 412, the PBR module 208 sends the overall number of reward points needed for settling the purchase amount with reward points. The calculation may be performed based on a conversion formula. It shall be noted that the conversion formula may be defined by issuer servers. In such instances, the conversion formula may be retrieved from the issuer database 204. Alternatively or additionally, the conversion formula may be defined by the payment server 112 and can be retrieved from the payment server database 212.

Upon receiving the number of reward points needed overall, the installment payment module 206 or the payment server 112, at 414, requests for a payment term plan to the issuer server 114.

At 416, the issuer server 114 checks for one or more criteria based on which one or more payment term plans may be determined. The one or more criteria include, but are not limited to, payment history associated with the payment card, available reward point in the card, other existing installment payments associated with the payment card, etc. It shall be noted that the issuer database 204 may store one or more generic installment plans for all cardholders. At 418, the issuer server 114 evaluates reward points balance based on the payment history and existing installment payment term plans.

At 420, the issuer server 114 determines the one or more payment term plans based on the one or more criteria. It shall be noted that in one embodiment, only an optimum payment term plan is determined by the issuer server 114. At 422, the issuer server 114 presents the one or more payment term plans to the cardholder 102 on the user device 104 in the issuer application. The payment term plans can be presented in a text message or an email or as a notification in the issuer application installed in the user device 104.

At 424, the cardholder 102 sends an approval (such as a response to the issuer server 114 sending the payment term plan) approving one payment term plan from among the one or more payment term plans to the issuer server 114. In an example, the issuer application may include actionable icons for approval or decline of the payment term plan. It shall be noted that if the payment term plan is declined, the issuer server 114 may present another payment term plan or redirect the user 102 to a payment authentication page managed by the issuer server 114.

At 426, a notification of approval is sent to the installment payment module 206. At the same time, the payment term plan is made accessible to the payment server 112. The payment term plan includes instructions for provisioning of direct payment from the payment card if available reward points with the payment card is less than the overall required number of reward points.

A user such as the user/cardholder 102 may have a plurality of payment cards issued by different issuers. While making purchase in an online purchase transaction the cardholder 102 may be willing to check the eligibility of each of the plurality of payment cards he/she is holding and request for available payment term plans for each of the plurality of payment cards. The cardholder 102 may wish to check if all the payment cards that he/she holds are eligible for installment payment by reward points for the purchase amount.

The cardholder 102, may however, have to have a wallet application installed in the user device 104 and has to add the plurality of payment cards in the wallet application in order to be able to check if the payment cards are eligible for installment payment by reward points. It shall be noted that the digital wallet application may be managed by the payment server 112. The cardholder 102 may create a wallet account which is linked to the payment server 112. The cardholder 102 may login to the wallet application to add or remove payment cards from the wallet account. Alternatively, the digital wallet application may be a third-party wallet application and identified as a secured environment by the payment server 112 for adding payment cards data.

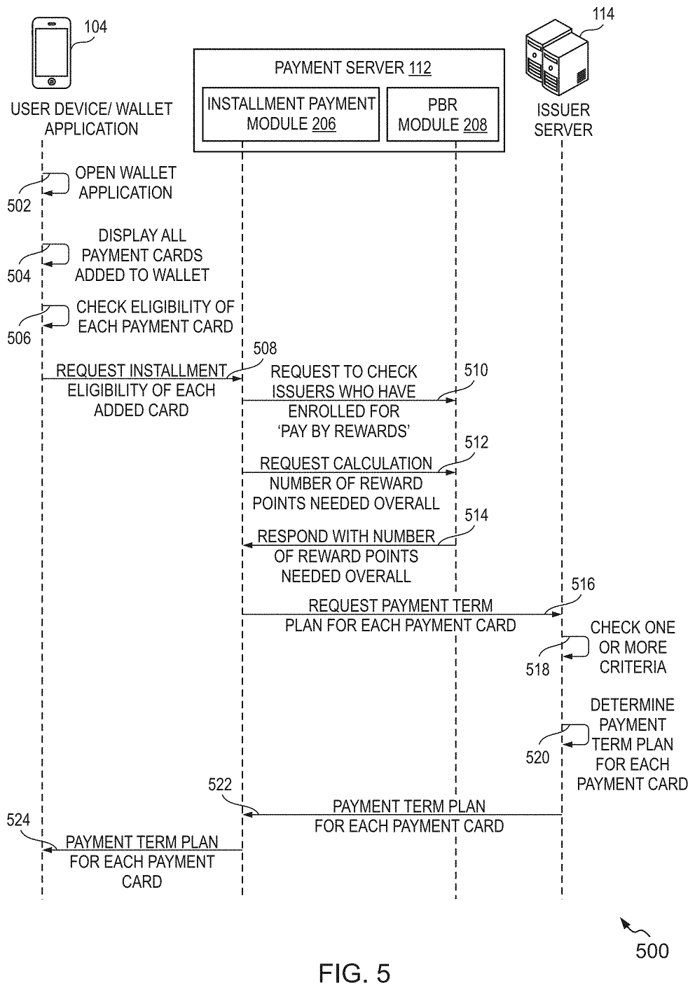

FIG. 5 represents a sequence flow diagram 500 representing a method of presenting payment term plans for the plurality of payment cards of a cardholder added in a wallet application, in accordance with an example embodiment of the present disclosure.

At 502, the user 102 opens the wallet application on the user device 104. The user 102 may log in to a user account in the wallet application on the user device 104 by providing user credentials. As described earlier, the digital wallet application may be managed by the payment server 112. Alternatively, the digital wallet application may be a third-party wallet application and identified as a secured environment for adding payment cards by the payment server 112. The wallet application may be a mobile application or a desktop application, and can be made available from existing or future application stores.

At 504, the wallet application displays one or more payment cards that are added in the user account of the wallet application. It shall be noted that the one or more payment cards that are added in the user account of the wallet application may be associated with one or more payment servers and payment networks. If the wallet application is managed by the payment server 112, then, the payment server 112 may require approval from the other payment servers to access data and use data corresponding to payment cards associated with those payment servers. Further, if the wallet application is managed by a third-party server, similar approval may be necessary from all payment servers.

At 506, the user 102 checks if the one or more payment cards added to the wallet are eligible for installment payment with reward points. It shall be noted that the user may be provided with options in the wallet application to check the eligibility of each payment card individually or to check the eligibility of all the payment cards at once. It shall be noted that if an issuer server issuing one of the payment cards is enrolled for the feature of integrating installment payment with reward points, the cardholder 102 or the cardholder's payment card issued by the issuer is eligible for installment payment with reward points.

At 508, the user device 104 sends a request to the payment server 112 for receiving payment term plans in the wallet application. The request is received by the payment server 112. It shall be noted that the request is processed at the installment payment module 206 of the payment server 112. Alternatively, if the wallet application is a third-party application, the request would be received by the third-party server.

At 510, the installment payment module 206 checks if the issuer servers/issuers issuing the one or more payment cards in the wallet application have enrolled for integrating installment payment with reward points feature. The installment payment module 206 queries the payment server database 212 to access information corresponding to enrollment of the issuer servers for the installment payment with reward points feature. It shall be noted that if an issuer server (such as the issuer server 114) is not enrolled for the installment payment with reward points feature, then the payment server 112 may notify the cardholder 102 of the same and the cardholder 102 can request the issuer server 114 for such enrollment.

At 512, the installment payment module 206 sends a request to the PBR module 208 to calculate the number of reward points needed overall for the purchase amount. At 514, the PBR module 208 sends the calculated number of reward points needed overall to the installment payment module 206.

Upon receiving the calculated number of reward points needed overall, the installment payment module 206 or the payment server 112, at 516, requests for a payment term plan for each payment card to the issuer server 114. At 518, the issuer server 114 checks for one or more criteria based on which the payment term plan may be calculated for each payment card. The one or more criteria include, but are not limited to, payment history associated with the payment cards, available reward point in the payment cards, other existing installment payments associated with the payment cards, etc. It shall be noted that the issuer database 204 may store one or more generic installment plans for all cardholders.

At 520, the issuer server 114 determines the payment term plan for each payment card based on the one or more criteria. It shall be noted that an optimum payment terms for each payment card are determined by the issuer server 114. At 522, the issuer server 114 sends the payment term plans to the payment server 112. In an example, the issuer server 114 directly presents the payment term plans to the cardholder 102 on the user device 104 in the wallet application.

At 524, the payment server 112 presents the payment term plans for each payment card to the cardholder 102 on the user device 104. The payment term plans for each payment card can be presented in a text message or an email or as a notification in the wallet application installed in the user device 104.

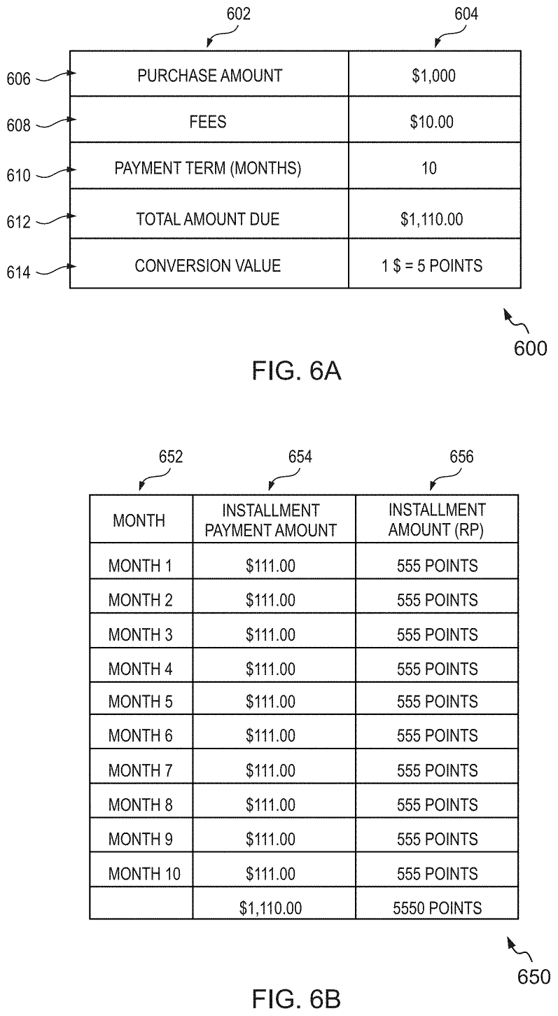

FIGS. 6A and 6B are example representations of tables 600 and 650 respectively, displaying a payment schedule of an installment payment with reward points, maintained at the issuer database 204, in accordance with an example embodiment of the present disclosure. As seen in FIG. 6A, the table 600 includes a column 602 listing various data associated with the payment schedule of an installment payment in a plurality of rows and their corresponding values in the column 604. As seen in FIG. 6A, the table 600, in the column 602 includes data such as a “Purchase Amount” in row 606, “fees” in row 608, “Payment Term” in row 610, “Total Amount due in row 612” and “Conversion value” in row 614. The column 604 includes the corresponding values for the data in the column 602. As an example, the ‘Purchase Amount’ is exemplarily depicted as $1000 in row 606, ‘fees’ is exemplarily depicted as $10 in row 608, ‘Payment Term’ is exemplarily depicted as 10 months in row 610, ‘Total Amount due’ is exemplarily depicted as $1110 (e.g., calculated based on adding interest of 10 percent) in row 612 and ‘Conversion value’ is exemplarily depicted as $1=5 reward points in row 614. The table 600 shown in FIG. 6A is exemplary and for the purposes of explanation. In practical, the issuer database 204 may include multiple such tables listing various data and each table may have fewer or more columns and rows than depicted in FIG. 6A. The table 650 may be an extended form of the table 600 shown in FIG. 6A.

As seen in FIG. 6B, the table 650 represents a payment term plan for the installment payment, and includes a column 652 listing payment term of installment payment in months for a purchase amount displayed in the table 600, a column 654 listing the installment payment amount in terms of currency and a column 656 listing the required reward points worth the installment payment amount in currency listed in column 652. The table 650 may include as many numbers of rows as the installment term in months. As an example, the number of months as shown in FIG. 6B is 10. The months are listed under column 652 in a plurality of rows, such as Month 1, Month 2, . . . , Month 10. The installment amount for every month is listed under column 654 in a plurality of rows corresponding to the months in column 652, such as, $111 for Month 1, $111 for Month 2, etc. Similarly, the required reward points worth the installment payment amount for each month is listed under column 656 in a plurality of rows corresponding to the installment payment amount in column 654, such as, $111=555 points, etc. The table 650 may include additional rows for depicting the total purchase amount and the required overall reward points as seen in FIG. 6B. The table 650 shown in FIG. 6B is exemplary and for the purposes of explanation. In practical, the issuer database 204 may include multiple such tables listing various data and each table may have fewer or more columns and rows than depicted in FIG. 6B. The payment term plan displayed in FIGS. 6A and 6B are for example purposes only, and the payment term plans, as such, can be customized to any extent by the user or from the issuer server. Also, any form of Equated Monthly Installment (EMI) calculation may apply and monthly installments may differ in different payment term plans and also for different users. For instance, one way of EMI calculation may include decreasing interest part and increasing principal part with each installment. Also, the user may choose to pay entire or certain percentage of principal amount by payment card account and interest amount by reward points, or vice versa.

The payment term plans are determined based on plurality of criteria, and one of the primary criteria includes usage history (e.g., spend habit using payment card) of payment card of the cardholder. It should be noted that if there are two dissimilar spend habits of two cardholders using different payment cards, different payment term plans may be suggested to the cardholders even if the purchase amount is same for both the cardholders.

FIGS. 7A and 7C are example representations of tables 700 and 750 illustrating retrieval of the reward points usage history associated with two distinct payment cards of the cardholder 102 issued by two distinct issuers, in accordance with an example embodiment of the present disclosure. FIGS. 7B and 7D are example representations of tables 720 and 770 respectively, displaying two distinct payment term plans for the purchase amount displayed in FIG. 6A based on the reward points usage history determined in FIGS. 7A and 7C, in accordance with an example embodiment of the present disclosure. It shall be noted that the tables 700, 720, 750 and 770 are stored in the issuer database 204 and the tables 720 and 770 are presented to the cardholder 102 on the user device 104. It shall be noted that the table 720 and 770 are two examples of payment term plans.

Referring to FIG. 7A, the table 700 displays reward points usage history associated with a payment card of the cardholder 102 issued by an issuer ‘Issuer 1’ for a period of 10 months. The table 700 includes an index portion 702 which displays information such as a PAN exemplarily depicted as ‘XXXXX1524X’, issuer bank exemplarily depicted as ‘Issuer 1’ and overall reward points required for installment payment of a purchase amount exemplarily depicted as ‘6000’ points. The information displayed in the index portion 702 is information associated with the cardholder's payment card.

As seen in FIG. 7A, the table 700 includes a column 704 listing a random number of months and a column 706 listing the listing the usage history of reward points in each of the months listed in the column 704. The table 700 may include as many numbers of rows as the number of months. As an example, the number of months as shown in FIG. 7A is 10. The months are listed under the column 704 in a plurality of rows, as Month 1, Month 2, . . . , Month 10. The reward points available in each of the months are listed under the column 706 in a plurality of rows corresponding to the months in the column 704, such as, 70 points in Month 1, 225 points in Month 2, 400 points in Month 3 and so on. The table 700 may include an additional row for depicting the total reward points available in a period of 10 months exemplarily depicted as ‘5875’ as seen in FIG. 7A.

Similarly, the table 7B displays a table 720 including an index portion 722 which displays information such as average reward points exemplarily depicted as ‘587.5’. The average reward point is calculated based on the total available reward points in a period of 10 months as displayed in table 700. The index portion 722 further displays a suggested installment term of installment payment in months.

As seen in FIG. 7B, the table 720 includes a column 724 listing a suggested installment term of installment payment (e.g. 10 months) or number of installments, a column 726 listing the required overall reward points based on the purchase amount displayed in the table 600 of FIG. 6A. The table 720 may include as many numbers of rows as the number of months. As an example, the number of months as shown in FIG. 7B is 11. The months are listed under the column 724 in a plurality of rows, such as Month 1, Month 2, . . . , Month 11. The reward points required to be maintained in each of the months are listed under the column 726 in a plurality of rows corresponding to the months in the column 724, such as, 545 points in Month 1, 545 points in Month 2, 545 points in Month 3 and so on. The table 720 may include an additional row for depicting the total reward points to be maintained at the end of 11 months as seen in FIG. 7B.

Referring to FIG. 7C, the table 720 is a variation of the table 700. An index portion 752 displays information such as a PAN exemplarily depicted as ‘XXXXX1524X’, issuer bank exemplarily depicted as ‘Issuer 2’ and overall reward points required for a purchase amount exemplarily depicted as ‘6000’ points. As seen in FIG. 7C, the table 750 includes a column 754 listing a random number of months and a column 756 listing the listing the history of reward points in each of the months listed in the column 754. The table 750 may include as many numbers of rows as the number of months. As an example, the number of months as shown in FIG. 7C is 5. The months are listed under the column 754 in a plurality of rows, such as Month 1, Month 2, . . . , Month 5. The reward points available in each of the months are listed under the column 756 in a plurality of rows corresponding to the months in the column 754, such as, 700 points in Month 1, 935 points in Month 2, 915 points in Month 3 and so on. The table 750 may include an additional row for depicting the total reward points available in a period of 5 months exemplarily depicted as 9605 as seen in FIG. 7A.

Similarly, the table 7D displays a table 770 including an index portion 772 which displays information such as average reward points exemplarily depicted as ‘1921’. The average of reward points is calculated based on the total available reward points in a period of 5 months as displayed in table 750. The index portion 772 further displays a suggested installment term of installment payment in months.

As seen in FIG. 7D, the table 770 includes a column 774 listing a suggested installment term of installment payment (e.g. 4 months) or number of installments, a column 776 listing the required overall reward points based on the purchase amount displayed in the table 600 of FIG. 6A. The table 770 may include as many numbers of rows as the number of months. As an example, the number of months as shown in FIG. 7D is 4. The months are listed under the column 774 in a plurality of rows, such as Month 1, Month 2, . . . , Month 4. The reward points required to be maintained in each of the months are listed under the column 776 in a plurality of rows corresponding to the months in the column 774, such as, 1500 points in Month 1, 1500 points in Month 2, 1500 points in Month 3 and so on. The table 770 may include an additional row for depicting the total reward points to be maintained at the end of 4 months as seen in FIG. 7D.

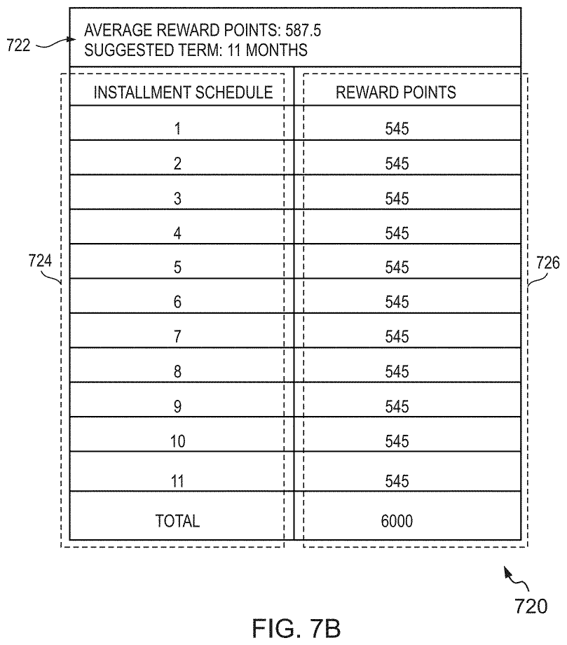

FIG. 8 illustrates a flow diagram of a method 800 for facilitating access to a payment term plan suggested to a cardholder by an issuer server, in accordance with one embodiment of the present disclosure. The method 800 depicted in the flow diagram may be executed by a server system, for example, the payment server 112. Operations of the flow diagram 800, and combinations of operation in the flow diagram 800, may be implemented by, for example, hardware, firmware, a processor, circuitry and/or a different device associated with the execution of software that includes one or more computer program instructions. The operations of the method 800 are described herein with help of the payment server 112. It is noted that the operations of the method 800 can be described and/or practiced by using a system other than the payment server 112. The method 800 starts at operation 802.

At 802, a request for an installment payment for a purchase amount is received. The installment payment is to be paid at least partially from reward points available with a payment card of a cardholder such as the cardholder 102.

At 804, a required number of reward points for a payment of the purchase amount is determined in response to the request for the installment payment. The required number of reward points for a payment of the purchase amount is obtained by conversion of the purchase amount into reward points based on a conversion formula. It shall be noted that the conversion formula may be defined by issuer servers. In such instances, the conversion formula may be retrieved from the issuer database. Alternatively or additionally, the conversion formula may be defined by the payment server 112 and can be retrieved from the payment server database 212.

At 806, a payment term plan for the installment payment is accessed. The payment term plan is determined based at least on the required number of reward points. The payment term plan includes a set of reward points needed to be used for payment corresponding to each installment of the installment payment.

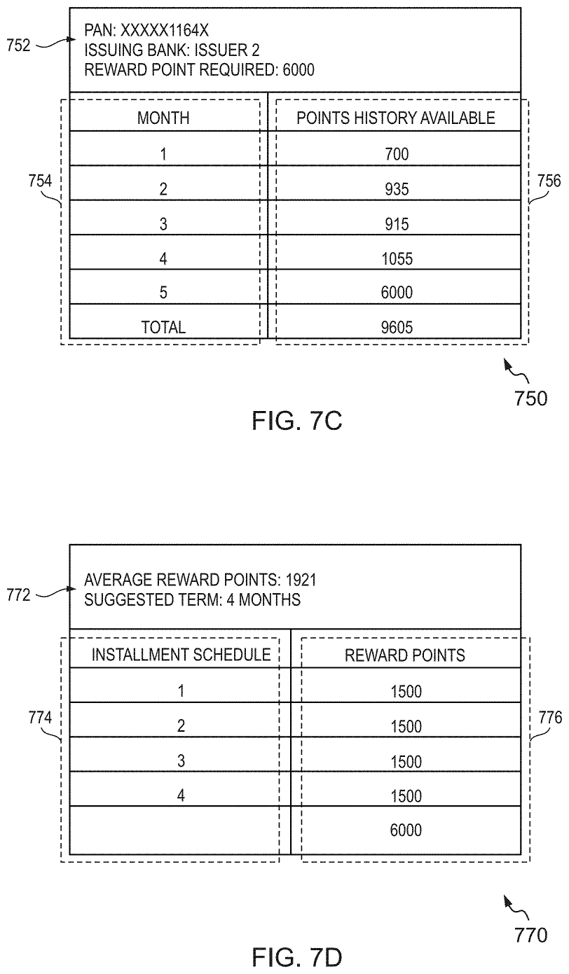

FIG. 9 is a simplified block diagram of a server system 900 used for presenting/suggesting a payment term plan to a cardholder, in accordance with one embodiment of the present disclosure. Examples of the server system 900 include, but are not limited to, the acquirer server 110, the payment server 112 and the issuer server 114 illustrated in FIG. 2. The server system 900 includes a computer system 905 and a database 910.

The computer system 905 includes at least one processor 915 for executing instructions. Instructions may be stored in, for example, but not limited to, a memory 920. The processor 915 may include one or more processing units (e.g., in a multi-core configuration). The processor 915 is operatively coupled to a communication interface 925 such that computer system 905 is capable of communicating with a remote device (such as the user device 104) or communicating with any entity within the payment network 108. For example, the communication interface 925 may receive an installment term plan request and a purchase request from the user device 104.

The processor 915 may also be operatively coupled to the database 910. The database 910 is any computer-operated hardware suitable for storing and/or retrieving data, such as, but not limited to, transaction data generated as part of sales activities conducted over the bankcard network including data relating to merchants, account holders or cardholders/users, and purchases. The database 910 may also store information related to a plurality of user's issuer accounts. Each issuer account data includes at least one of a cardholder name, a cardholder address, an account number, MPIN, and other account identifier. The database 910 may also store information of a plurality of merchants. The database 910 may also include instructions for settling transactions including merchant bank account information. The database 910 may include multiple storage units such as hard disks and/or solid-state disks in a redundant array of inexpensive disks (RAID) configuration. The database 910 may include a storage area network (SAN) and/or a network attached storage (NAS) system.

In some embodiments, the database 910 is integrated within computer system 905. For example, the computer system 905 may include one or more hard disk drives as the database 910. In other embodiments, the database 910 is external to the computer system 905 and may be accessed by the computer system 905 using a storage interface 930. The storage interface 930 is any component capable of providing the processor 915 with access to the database 910. The storage interface 930 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 915 with access to the database 910.

The processor 915 is configured to facilitate a payment transaction from an issuer account to an acquirer account (merchant account). The processor 915 is further configured to facilitate the authentication of a cardholder by verifying a PIN/OTP, etc. Thereafter, the processor 915 is configured to facilitate the payment transaction of the transaction amount from the issuer account of the user 102 to acquirer account of the merchant. The processor 915 may also be configured to notify the user device 104 of the transaction status via the communication interface 925.

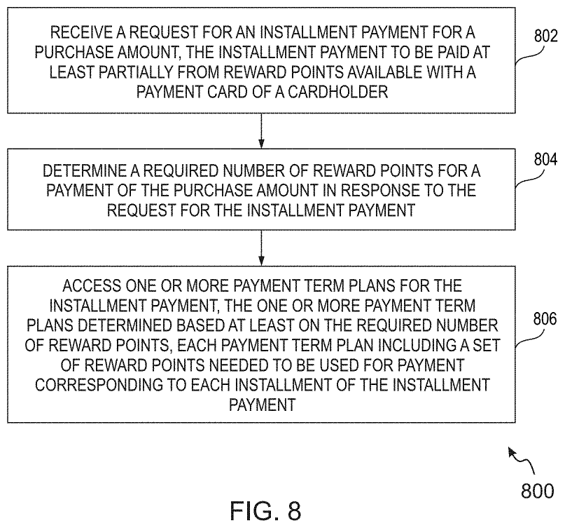

FIG. 10 is a simplified block diagram of an issuer server 1000 used for presenting/suggesting a payment term plan to a cardholder, in accordance with one embodiment of the present disclosure. The issuer server 1000 is an example of the issuer server 114 of FIG. 1, or may be embodied in the issuer server 114. The issuer server 1000 is associated with an issuer bank/issuer, in which a cardholder (such as the cardholder 102) may have an account, which provides a payment card. The issuer server 1000 includes a processing module 1005 operatively coupled to a storage module 1010, a verification module 1015, a communication module 1025, an application module (API) 1020, a notification module 1045, an installment plan determination module 1040 and an issuer database 1035. The issuer database 1035 is an example of the issuer database 204. The components of the issuer server 1000 provided herein may not be exhaustive and that the issuer server 1000 may include more or fewer components than that of depicted in FIG. 10. Further, two or more components may be embodied in one single component, and/or one component may be configured using multiple sub-components to achieve the desired functionalities. Some components of the issuer server 1000 may be configured using hardware elements, software elements, firmware elements and/or a combination thereof.

The storage module 1010 is configured to store information related to, contact information of the cardholder, bank account number, availability of funds in the issuer account, payment card details, transaction related information of users, payment history, reward points usage history and/or the like. This information is retrieved by the installment plan determination module 1040 for determining the payment term plan for the cardholder/payment card of the cardholder against a purchase amount.

A payment record database 1050 and a rewards points table 1055 are embodied within the issuer database 1035. The payment record database 1050 stores information corresponding to payment history associated with issuer accounts and payment cards of the cardholder 102. The rewards points table 1055 stores reward points usage history and/or the like.

The processing module 1005 is configured to communicate with one or more remote devices such as a remote device 1030 using the communication module 1025 over a network such as the payment network 108 of FIG. 1. The examples of the remote device 1030 include the payment server 112, the acquirer server 110, and the user device 104 or other computing systems of issuer and the payment network 108 and the like. The communication module 1025 is capable of facilitating such operative communication with the remote devices and cloud servers using API calls facilitated by the application module 1020. The communication module 1025 is configured to receive payment transaction request from the user device 104 via the payment network 108. The notification module 1045 is configured to present a payment term plan determined by the installment plan determination module 1040 to the user device 104. The notification module 1045 further sends notification of approval or decline of a transaction to remote devices such as the user device 104.

The application module 1020 further facilitates an application interface at the user device 104 through which the cardholder 102 and the issuer server 1000 can communicate. The application module 1020 allows API calls between the user device 104 and the issuer server 1000.

The verification module 1015 is configured to verify and validate a cardholder (such as the cardholder 102) and the user device 104 associated with the cardholder 102 for approving a payment transaction. The verification module 1015 may also verify if an issuer account of the cardholder associated with payment card have good standing balance.

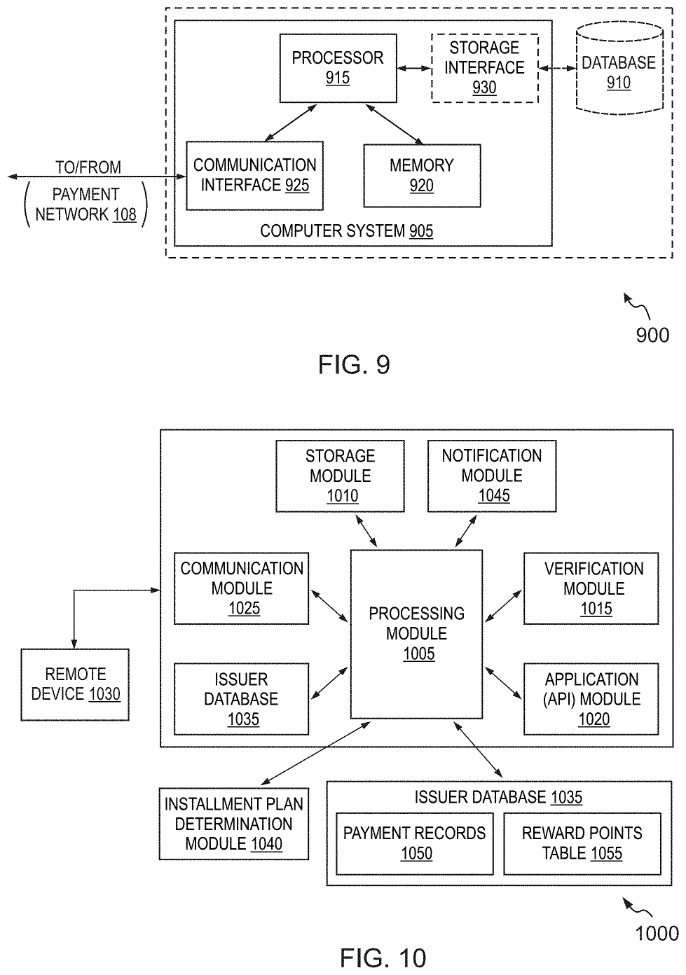

FIG. 11 is a simplified block diagram of an acquirer server 1100 used for presenting/suggesting a payment term plan to a cardholder, in accordance with one embodiment of the present disclosure. The acquirer server 1100 is associated with an acquirer bank, which may be associated with a merchant. The merchant may have established an acquirer account to accept payment for purchase of items from users. The acquirer server 1100 is an example of the acquirer server 110 of FIG. 1 or may be embodied in the acquirer server 110. Further, the acquirer server 1100 is configured to facilitate payment transaction with the issuer server 1000 using a payment network, such as the payment network 108 of FIG. 1. The acquirer server 1100 includes a processing module 1105 communicably coupled to a merchant database 1110 and a communication module 1115. The components of the acquirer server 1100 provided herein may not be exhaustive, and that the acquirer server 1100 may include more or fewer components than that of depicted in FIG. 11. Further, two or more components may be embodied in one single component, and/or one component may be configured using multiple sub-components to achieve the desired functionalities. Some components of the acquirer server 1100 may be configured using hardware elements, software elements, firmware elements and/or a combination thereof.

The merchant database 1110 includes one or more merchant parameters, such as, but not limited to, a merchant primary account number (PAN), a merchant name, a merchant ID (MID), a merchant category code (MCC), a merchant city, a merchant postal code, an MAID, a merchant brand name, terminal identification numbers (TIDs) associated with merchant terminals (e.g., the POS terminals or any other merchant electronic devices) used for processing transactions. The processing module 1105 is configured to use the MID or any other merchant parameter such as the merchant PAN to identify the merchant during the normal processing of payment transactions, adjustments, chargebacks, end-of-month fees, loyalty programs associated with the merchant and so forth. The processing module 1105 may be configured to store and update the merchant parameters in the merchant database 1110 for later retrieval. In an embodiment, the communication module 1115 is capable of facilitating operative communication with a remote device 1120 such as the issuer server 1000 or a merchant device (not shown).

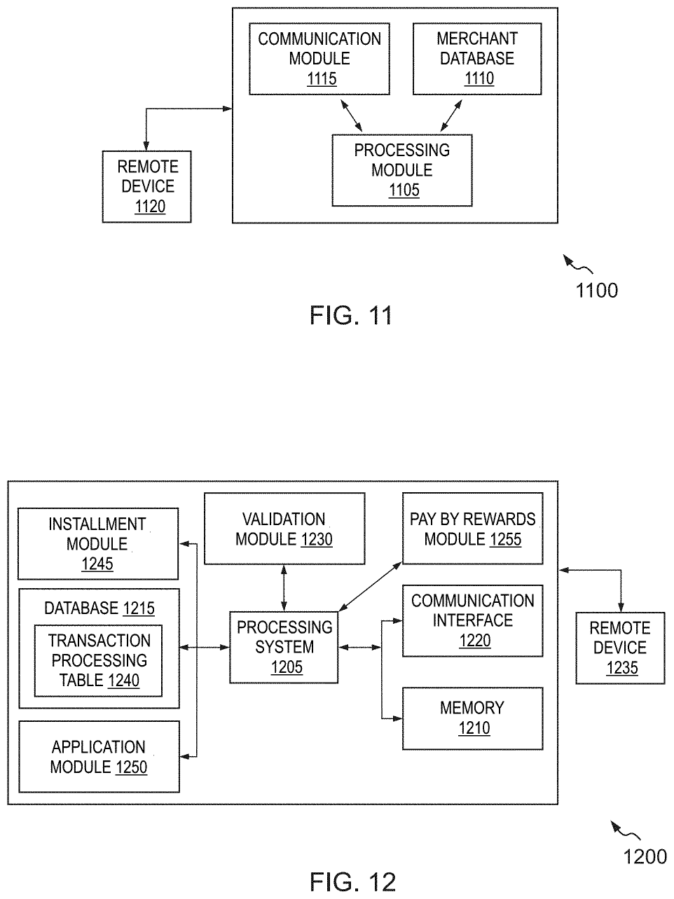

FIG. 12 is a simplified block diagram of a server system such as a payment server 1200 used for presenting/suggesting a payment term plan to a cardholder, in accordance with one embodiment of the present disclosure. The payment server 1200 may correspond to payment server 112 of FIG. 1. The payment network 108 may be used by the payment server 1200, the issuer server 1000 and the acquirer server 1100 as a payment interchange network. Examples of payment interchange network include, but not limited to, Mastercard® payment system interchange network. The payment server 1200 includes a processing system 1205 configured to extract programming instructions from a memory 1210 to provide various features of the present disclosure. The components of the payment server 1200 provided herein may not be exhaustive and that the payment server 1200 may include more or fewer components than that of depicted in FIG. 12. Further, two or more components may be embodied in one single component, and/or one component may be configured using multiple sub-components to achieve the desired functionalities. Some components of the payment server 1200 may be configured using hardware elements, software elements, firmware elements and/or a combination thereof.

Via a communication interface 1220, the processing system 1205 receives the payment transaction request from a remote device 1235 such as the user device 104 or the acquirer server 1100. The communication may be achieved through API calls facilitated by the application module 1250, without loss of generality. A transaction processing table 1240 is embodied in a database 1215. The transaction processing table 1240 stores the cardholder parameters and payment details, acquirer account information, transaction records, merchant account information, and the like. Further, the transaction processing table 1240 also stores details such as Issuer ID, country code, acquirer ID, and Merchant ID, among others. Upon receiving a payment transaction request, the payment server 1200 may perform a lookup into the transaction processing table 1240 to identify the authenticity of the Merchant ID.

The application module 1250 further facilitates an application interface at a device of the issuer through which the issuer can enroll for integrating installment payment with reward points feature. The application module 1250 allows API calls between an installment payment module 1245 and a PBR module 1255.

The installment payment module 1245 is configured to facilitate a digital platform/interface of the payment server 1200 allowing issuer servers such as the issuer server 1000 to enroll for integration of installment payments with the pay by rewards facility. The installment payment module 1245 allows the issuer server 1000 to define fields with an instruction to integrate installment payment with pay by rewards. The payment module 1245 is further configured to notify the issuer server 1000 on how much installment amount is to be collected from cardholders on a monthly basis. The installment payment module 1245 and the PBR module 1255 are in operative communication through the network 106 as and when the cardholder 102 requests for available payment term plans and when a cardholder 102 makes a purchase. The PBR module 1255 is configured to convert a purchase amount into reward points based on conversion formula.

The cardholder details, the payment details, the issuer account balance, etc., are validated using a validation module 1230. The validation module 1230 may include one or more predefined rule sets using which the processing system 1205 can process the validation. Further, the processing system 1205, upon successful validation, sends transaction amount and the merchant parameters to the acquirer server (e.g., 1100) for crediting the merchant account with the transaction amount. The processing system 1205 is further configured to notify the remote device 1235 of the transaction status via the communication interface 1220.

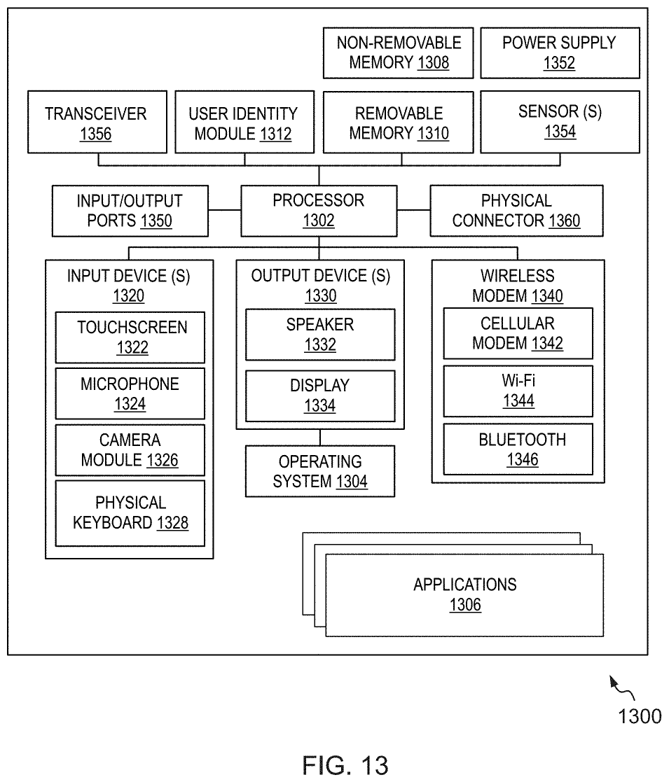

FIG. 13 shows simplified block diagram of a user device 1300 (such as the user device 104). The user device 1300, for example, can be a desktop computer or a mobile phone capable of implementing the various embodiments of the present disclosure. The user device 1300 is depicted to include one or more applications 1306 managed by the payment server 1200.

It should be understood that the user device 1300 as illustrated and hereinafter described is merely illustrative of one type of device and should not be taken to limit the scope of the embodiments. As such, it should be appreciated that at least some of the components described below in connection with that the user device 1300 may be optional and thus in an example embodiment may include more, less or different components than those described in connection with the example embodiment of the FIG. 13. As such, among other examples, the user device 1300 could be any of an electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1300 includes a controller or a processor 1302 (e.g., a signal processor, microprocessor, ASIC, or other control and processing logic circuitry) for performing such tasks as signal coding, data processing, image processing, input/output processing, power control, and/or other functions. An operating system 1304 controls the allocation and usage of the components of the user device 1300 and support for one or more applications programs (see, payment server application 1306), that implements one or more of the innovative features described herein. The applications 1306 may include common mobile computing applications (e.g., telephony applications, email applications, calendars, contact managers, web browsers, messaging applications such as USSD messaging or SMS messaging or SIM Tool Kit (STK) application) or any other computing application.

The illustrated user device 1300 includes one or more memory components, for example, a non-removable memory 1308 and/or removable memory 1310. The non-removable memory 1308 and/or removable memory 1310 may be collectively known as database in an embodiment. The non-removable memory 1308 can include RAM, ROM, flash memory, a hard disk, or other well-known memory storage technologies. The removable memory 1310 can include flash memory, smart cards, or a Subscriber Identity Module (SIM). The one or more memory components can be used for storing data and/or code for running the operating system 1304 and the applications 1306. The user device 1300 may further include a user identity module (UIM) 1312. The UIM 1312 may be a memory device having a processor built in. The UIM 1312 may include, for example, a subscriber identity module (SIM), a universal integrated circuit card (UICC), a universal subscriber identity module (USIM), a removable user identity module (R-UIM), or any other smart card. The UIM 1312 typically stores information elements related to a mobile subscriber. The UIM 1312 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1300 can support one or more input devices 1320 and one or more output devices 1330. Examples of the input devices 1320 may include, but are not limited to, a touch screen/a display screen 1322 (e.g., capable of capturing finger tap inputs, finger gesture inputs, multi-finger tap inputs, multi-finger gesture inputs, or keystroke inputs from a virtual keyboard or keypad), a microphone 1324 (e.g., capable of capturing voice input), a camera module 1326 (e.g., capable of capturing still picture images and/or video images) and a physical keyboard 1328. Examples of the output devices 1330 may include, but are not limited to a speaker 1332 and a display 1334. Other possible output devices can include piezoelectric or other haptic output devices. Some devices can serve more than one input/output function. For example, the touch screen 1322 and the display 1334 can be combined into a single input/output device.

A wireless modem 1340 can be coupled to one or more antennas (not shown in the FIG. 13) and can support two-way communications between the processor 1302 and external devices, as is well understood in the art. The wireless modem 1340 is shown generically and can include, for example, a cellular modem 1342 for communicating at long range with the mobile communication network, a Wi-Fi compatible modem 1344 for communicating at short range with an external Bluetooth-equipped device or a local wireless data network or router, and/or a Bluetooth-compatible modem 1346. The wireless modem 1340 is typically configured for communication with one or more cellular networks, such as a GSM network for data and voice communications within a single cellular network, between cellular networks, or between the user device 1300 and a public switched telephone network (PSTN).

The user device 1300 can further include one or more input/output ports 1350 for establishing connection with peripheral devices, a power supply 1352, one or more sensors 1354 for example, an accelerometer, a gyroscope, a compass, or an infrared proximity sensor for detecting the orientation or motion of the user device 1300 and biometric sensors for scanning biometric identity of an authorized user, a transceiver 1356 (for wirelessly transmitting analog or digital signals) and/or a physical connector 1360, which can be a USB port, IEEE 1294 (FireWire) port, and/or RS-232 port. The illustrated components are not required or all-inclusive, as any of the components shown can be deleted and other components can be added.

Without in any way limiting the scope, interpretation, or application of the claims appearing below, a technical effect of one or more of the example embodiments disclosed herein is to provide computer implemented methods and server systems for facilitating installment payment for a purchase with reward points. Various embodiments of the present disclosure further provide systems and methods for facilitating calculation of a payment term plan based on one or more criteria, such as availability of reward points and payment history associated with a payment card of a user. Embodiments provide a payment server comprising an installment payment module and a PBR module that converts a purchase amount into reward points. The payment server further accesses a payment term plan determined by an issuer server based on one or more criteria. The installment plan is sent to a user device for approval by the user. Embodiments provide techniques to notify the issuer server on the required number of reward points on a monthly basis for determining the payment term plan.

The disclosed methods with reference to FIGS. 1 to 13 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 900 and various components such as the computer system 905 and the database 910 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAYED Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system associated with a payment network, a request for an installment payment for a purchase amount, the installment payment to be paid at least partially from reward points available with a payment card of a cardholder;
determining, by the server system, a required number of reward points for a payment of the purchase amount in response to the request for the installment payment; and
accessing, by the server system, one or more payment term plans for the installment payment, the one or more payment term plans determined based at least on the required number of reward points, each of the one or more payment term plans comprising a set of reward points needed to be used for payment corresponding to each installment of the installment payment.

2. The method as claimed in claim 1, further comprising:
facilitating, by the server system, sending a notification for an approval of a payment term plan from among the one or more payment term plans for the installment payment to the cardholder; and
upon receiving the approval of the cardholder, setting the installment payment as per the payment term plan.

3. The method as claimed in claim 2, wherein facilitating sending the notification comprises enabling an issuer server associated with the payment card to send the notification.

4. The method as claimed in claim 2, wherein receiving the approval further comprises receiving the approval of the cardholder via an issuer server prior to setting the installment payment.

5. The method as claimed in claim 1, wherein accessing the one or more payment term plans comprises facilitating determination of the one or more payment term plans based further on:
one or more card usage criteria of the payment card; and
total reward points available with the payment card.

6. The method as claimed in claim 5, wherein the one or more card usage criteria include a payment history of the payment card.

7. The method as claimed in claim 5, wherein payment term plans determined for a first user and a second user are different based on corresponding one or more card usage criteria and total reward points available for each of the first user and the second user.

8. The method as claimed in claim 5, wherein facilitating determination of the one or more payment term plans comprises:
sending the request for installment payment and the number of reward points to an issuer server associated with the payment card; and
receiving the one or more payment term plans from the issuer server, wherein the issuer server determines the one or more payment term plans, each of the one or more payment term plans comprising
a number of installments for the installment payment, and
the set of reward points needed for payment corresponding to each installment of the number of installments.

9. The method as claimed in claim 5, further comprising enabling an issuer server to enroll for integration of an installment payment with reward points feature with the server system.

10. The method as claimed in claim 1, wherein the payment term plan comprises provisioning of direct payment from the payment card if available reward points with the payment card is less than the set of reward points.

11. The method as claimed in claim 1, further comprising, by the server system, linking a wallet account to the server system, wherein the payment card is added to the wallet account.

12. A payment server in a payment network, comprising:
a memory comprising stored instructions; and
a processor configured to execute the stored instructions to perform a method comprising:
receiving a request for an installment payment for a purchase amount, the installment payment to be paid at least partially from reward points available with a payment card of a cardholder,
determining a required number of reward points for a payment of the purchase amount in response to the request for the installment payment,
accessing a payment term plan for the installment payment, the payment term plan determined based at least on the required number of reward points, the payment term plan comprising a set of reward points needed to be used for payment corresponding to each installment of the installment payment,
facilitating sending a notification for an approval of the payment term plan for the installment payment to the cardholder, and
upon receiving the approval of the cardholder, setting the installment payment as per the payment term plan.

13. The payment server as claimed in claim 12, wherein for facilitating sending the notification, the processor is further configured to perform enabling an issuer server associated with the payment card to send the notification.

14. The payment server as claimed in claim 12, wherein for receiving the approval, the processor is further configured to perform receiving the approval of the cardholder via an issuer server prior to setting the installment payment.

15. The payment server as claimed in claim 12, wherein for accessing the payment term plan, the processor is further configured to facilitate determination of the payment term plan based further on:
one or more card usage criteria of the payment card; and
total reward points available with the payment card.

16. The payment server as claimed in claim 15, wherein the one or more card usage criteria include a payment history of the payment card.

17. The payment server as claimed in claim 15, wherein for facilitating determination of the payment term plan, the processor is further configured to:
send the request for installment payment and the number of reward points to an issuer server associated with the payment card; and
receive the payment term plan from the issuer server, wherein the issuer server determines the payment term plan, the payment term plan comprising:
a number of installments for the installment payment; and
the set of reward points needed for payment corresponding to each installment of the number of installments.

18. The payment server as claimed in claim 15, wherein the payment server is further configured to enable an issuer server to enroll for integration of an installment payment with reward points feature with the payment server.

19. A payment server in a payment network, comprising:
an installment payment module configured to receive a request for an installment payment for a purchase amount, the installment payment to be paid at least partially from reward points available with a payment card of a cardholder;
a pay by reward module configured to determine a required number of reward points for a payment of the purchase amount in response to the request for the installment payment; and
a communication interface configured to, upon instructions received from the pay by reward module:
send the required number of reward points and the request for the installment payment to an issuer server associated with the cardholder,
receive one or more payment term plans for the installment payment from the issuer server, the one or more payment term plans determined based at least on the required number of reward points by the issuer server, each of the one or more payment term plans comprising a set of reward points needed to be used for payment corresponding to each installment of the installment payment,
send a request to the issuer server to for an approval of a payment term plan from among the one or more payment term plans for the installment payment from the cardholder, and
receive the approval of the cardholder for the payment term plan via the issuer server,
wherein the pay by reward module is further configured to set the installment payment as per the payment term plan.
